(19) United States
(12) Patent Application Publication
(10) Pub. No.: US 2002/0111937 A1
(43) Pub. Date: Aug. 15, 2002

(54) Method and system for permissible internet direct marketing

(76) Inventors: Mark Wetherbee, Ft. Lauderdale, FL (US); Paul Wasserman, Chicago, IL (US)

Correspondence Address: Adam K. Sacharoff, Hamman & Benn, 10 South LaSalle Street, Chicago, IL, 60603, US

(21) Appl. No.: 10/011,177

(22) Filed: Dec. 5, 2001

Related U.S. Application Data
(60) Provisional application No. 60/264,750, filed on Jan. 29, 2001.

(51) Int. Cl. G06F 7/00

(52) U.S. Cl. 707/1

(57) ABSTRACT

A system for delivery of Internet messages includes a means for receiving a plurality of records contained within a database, wherein each record has information associated to at least one recipient. A means for identifying a unique identification for each recipient and a means for creating a unique Internet address based upon said unique identification, wherein the recipient does not create the unique identification. A means for receiving a message containing specific information directed to specific recipients in the database and a means for identifying the specific recipients, of the database, creating a list of identified recipients for which the message is directed to. The means for identifying is based upon matching the information associated to the identified recipients to the specific information contained in the message. A means for directing the message to the unique Internet address of the identified recipients.

### CROSS REFERENCE TO RELATED APPLICATIONS

This application claims the benefit of U.S. Provisional Patent Application having Serial No. 60/264,750 and filed on Jan. 29, 2001 and hereby incorporated by reference.

### FIELD OF THE INVENTION

The present invention relates to a method and system for permissible Internet direct marketing by structuring a messaging system that links a unique identifier to an entity or residence.

### BACKGROUND OF THE INVENTION

In a conventional Internet messaging system, a message is originated by a sender and delivered to one or more recipients. Delivery is contingent on sending the message to the recipient's e-mail address. However, various problems arise in this type of messaging system.

The first problem arises out of the recipient's e-mail address. An e-mail address broadly written as <name>@<domain name> consists of two parts. The first part <name> is typically a creation by the recipient and is often times personal to the recipient. The second part <domain name> identifies an Internet protocol (IP) address, which typically identifies a specific company such as the recipient's place of business or the recipient's service provider. The <domain name> also contains a top level domain suffix such as “.com” or “.gov”. Unfortunately when the recipient changes jobs or switches to a different service provider, the domain name will change and even their first part of the e-mail address may change. Therefore, the ability for a sender to keep an accurate and updated list of e-mail addresses is extremely difficult over time. In fact, if the recipient does not inform the user of the change in their e-mail address the sender will not be able to contact the recipient at all.

Another problem results in unsolicited and non-targeted e-mail campaigns, called SPAM, which are not considered an acceptable method of marketing on the Internet. Attempts to create permissible internet-based marketing systems include OPT-IN e-mail lists; of which there are too few quality lists available that permit e-mail direct marketers to reach their core audiences. Moreover, there are attempts by Internet Service Providers (ISP's) to create and maintain advanced e-mail blocking technologies to keep uninvited Internet messages from penetrating their servers.

In addition, compiling and maintaining true opt-in e-mail lists requires companies to adhere to painstaking procedures and standards. Handling e-mail replies and unsubscribe requests are costly, error prone and often lead to companies sending unsolicited e-mails. Opt-in e-mail addresses within companies are also prone to inaccuracies due to ongoing personnel changes. And opt-in lists that are sold and used by 3^{rd} parties are still considered a type of spamming. Problems also arise when e-mail list providers license their lists for a single use, but have no way to regulate the amount of times the e-mail list is used.

For businesses, there is no easy way to receive and direct incoming messages to their business departments and employees without managing their own internal e-mail systems. No standards exist for electronic marketing via e-mail to business locations. In addition, there is no easy way for businesses to send messages to customers or consumers, because there is no means to keep e-mail addresses updated and accurate.

Various forms of messaging systems exist in the prior art. However, these prior art systems do not overcome the problems listed above. For example, U.S. Pat. No. 6,108,691 to Lee et al. discloses a method for setting up a directory service that allows a user to receive e-mail messages from senders without requiring the user to reveal his/her e-mail address. The directory service maintains users' e-mail addresses but allows users to restrict the display of their e-mail addresses. The directory service can cause a message to be sent from a sender to a recipient without revealing the recipient's e-mail address. However, the service must predicate itself on maintaining an updated list of recipient e-mail addresses.

U.S. Pat. No. 6,073,167 to Poulton et al. discloses a search engine that searches web pages according to specific criteria and pulls any e-mail addresses out of the pages to compile a list of e-mail addresses corresponding to the web pages. The engine will also categorize the addresses depending upon whether the addresses specifically relate to the web page or are connected to another separate web page.

U.S. Pat. No. 5,854,897 to Radziewicz et al. describes a marketing system that sends advertisements into a browser, when the connection between the two is idle for a specific period of time.

U.S. Pat. No. 5,724,424 to Gifjord discloses a system for purchasing goods or information over a computer network. A buyer viewing an advertisement is permitted to buy the goods or information advertised from the seller by answering the advertisement.

U.S. Pat. No. 5,632,018 to Otorii discloses an electronic mail system that permits a person sending a broadcast e-mail, to a group of users, to toggle any response thereto, such that a user receiving such e-mail may respond not only to the original sender but also to everyone else who received the broadcast e-mail.

U.S. Pat. No. 4,800,488 to Agrawal et al. describes a method for advertising. The method describes a computer sending an advertisement to all or partially enabled network computers listed in its client database. The system also will check to determine if the client computer is on-line, if so the client is provided with the means to answer the advertisement in a private communication path established between the two.

Moreover, various other prior art messaging systems deal with filtering unwanted e-mail or dealing with “Spam-mail.” For example, U.S. Pat. No. 6,072,942 to Stockwell et al. describes a method of filtering e-mail through a series of nodes to establish whether the mail should be delivered and to whom. The nodes are user defined and will be based upon the corporation or commercial security policy. The messages being filtered can also be passed along multiple routing paths depending upon such defined parameters.

U.S. Pat. No. 6,023,723 permits one to filter the incoming e-mail into unwanted or “blocked mail,” “wanted mail” and “unknown,” which is sent to a waiting room. U.S. Pat. No. 5,999,932 filters mail as okay if the e-mail matches information from an inclusion list, “new” if it matches certain other criteria and “junk” for everything else. U.S. Pat. No. 5,619,648 to Canale et al. discloses another method of filtering e-mail received by a user of an e-mail system. U.S. Pat. No. 5,377,354 also describes a method for filtering, sorting and prioritizing e-mail messages.

Other methods, such as U.S. Pat. No. 5,944,787 attempt to cross-reference e-mail addresses to postal information demonstrating an attempt to gather demographic information for marketing purposes. However, no accurate methods exists to link e-mail addresses to residential addresses, which would enable Public Utilities to pinpoint communications such as invoices, announcements, and receive payments adequately.

No method yet exists to provide an acceptable means of delivering and receiving Internet messages while protecting the privacy of the recipient and permitting the Internet messaging sender the ability to send information without the threat of spamming.

It is thus desirable to provide a method and system to create Internet addresses, which can be cross-referenced to any and all records in a database, that allows Internet messaging providers to send information, and provides the recipients a source to receive the information that protects their anonymity, reduces technology costs for security to prevent costly volumes of messages, and allow accurate, timely delivery of Internet communications.

As new technologies proliferate, Internet messages can also be delivered to devices and virtual locations other than to e-mail addresses. Such delivery points currently include cellular phones, IP addresses, other IP devices such as IP telephones, and software-to-software messaging. Future systems may include embedded systems in home appliances, utility metering devices, and other as yet unknown devices and virtual locations.

These all share in common a uniquely identifiable address and the ability to receive some form of message over the Internet or other ubiquitous communications infrastructure. References in this application to e-mail addressing apply equally to such other delivery points and communications infrastructure as exist now, or may become available in the future.

### SUMMARY OF THE INVENTION

The present invention is a messaging system, and method of operation thereof, which provides Internet messaging providers, such as direct-marketers, e-commerce businesses, public and private, and message recipients with control over the delivery of messages. This system manages Internet messaging by assigning, organizing and managing multiple delivery point e-mail addresses for commercial businesses and residential addresses.

This system permits acceptable Internet messaging by providing a unique Internet address and receptacle for Internet messaging providers to send Internet messages to all businesses and residential addresses without spamming private e-mail addresses. Additionally, this system permits all messaging recipients to review and query information without jamming their own private e-mail systems.

According to the present invention a unique Internet address is created and linked to every record in a database. Internet messaging providers will not know the specific unique Internet addresses and as such must use the system to send messages to the recipients. The system will assign unique Internet addresses based upon a unique identifier in a database such as USPS postal location (11-digit, delivery-point zip code) DUNS number, account number, department type, and/or position within the database that can identify a specific recipient but may not be dependent upon a specific recipient.

Providing the unique Internet addresses and linking them to an entity permits Internet messaging providers to control and pinpoint the delivery of their messages for marketing, billing, informing, etc. This method removes privacy issues since the messages are sent to Internet addresses that are provided by the system, rather than the recipients private email addresses. This method also sets the foundation for public utility companies to manage and control the delivery of their communications via the Internet since this method creates the recipients address similar, in principle, to the fact that the United States Postal Service (USPS) has created snail-mail addresses for paper-based communications.

The system thus would provide utility companies the ability to accurately communicate with their customers, since currently they have no other way to use the Internet for communications except to use private e-mail addresses, which again, become inaccurate and outdated.

### BRIEF DESCRIPTION OF THE DRAWINGS

The details of the present invention, both as to its structure and operation, can best be understood by referring to the accompanying drawings, in which like reference numbers and designations refer to like elements:

FIG. 1 is a block diagram of a system for permissible Internet direct messaging in accordance with one embodiment of the present invention;

FIG. 2 is a block diagram illustrating a messaging server, in accordance with one embodiment of the present invention, receiving a plurality of customer databases;

FIG. 3 is an exemplary customer database, illustrating various information that may be contained therein;

FIG. 4 is an illustration of the system for permissible Internet direct messaging in accordance with one embodiment of the present invention;

FIG. 5a is an exemplary illustration of a customer database linked to an unique Internet address database created by the messaging server in accordance with one embodiment of the present invention;

FIG. 5b is another exemplary illustration of a customer database linked to an unique Internet address database created by the messaging server in accordance with another embodiment of the present invention;

FIG. 6 is a block diagram illustration the messaging server directing messages from various messaging providers to various recipients in accordance with one embodiment of the present invention;

FIG. 7 is a block diagram illustrating a messaging server owned and operated by a business with its own customer database linked to various residences, wherein each residence has their own IP address, permitting the business and other outside entities to direct messages to the residences; and

FIG. 8 is one method in accordance with one embodiment of the present invention.

### DETAILED DESCRIPTION OF THE INVENTION

While the invention is susceptible to embodiments in many different forms, there are shown in the drawings and will be described herein, in detail, the preferred embodiments of the present invention. It should be understood, however, that the present disclosure is to be considered an exemplification of the principles of the invention and is not intended to limit the spirit or scope of the invention and/or claims of the embodiments illustrated.

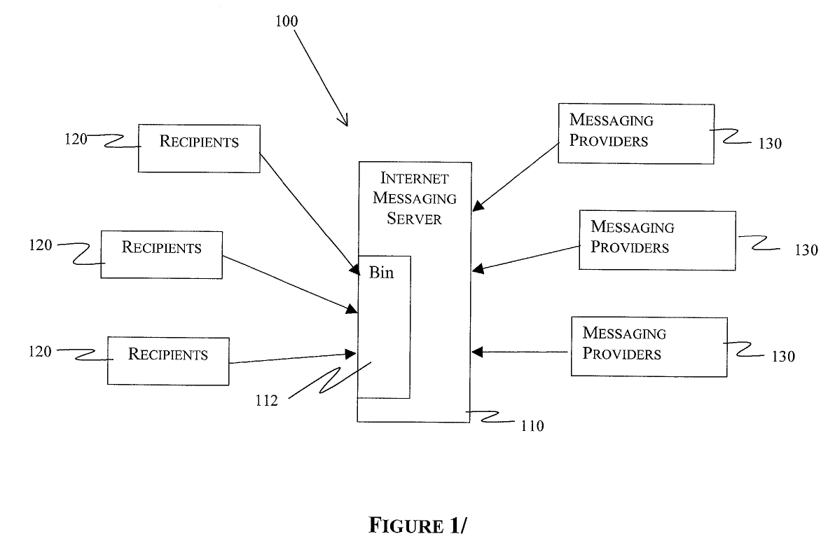

In accordance with the present invention, a method and system for permissible Internet direct messaging is provided. Referring first to FIG. 1, there is illustrated a system 100 for permissible Internet direct messaging in accordance with one embodiment of the present invention. As illustrated, the system 100 includes a messaging server 110, a plurality of recipients 120 and a plurality of messaging providers 130. The messaging server 110 is typically contained or running on a computer or workstation, but may also be a mini-computer or mainframe. The messaging providers 130 may include direct marketers, e-commerce businesses, public and private businesses as well as individuals. The recipients 120 may similarly include e-commerce businesses, public and private businesses as well as individuals.

The messaging server 110 provides acceptable Internet e-mail messaging by providing a unique Internet address and receptacle for the messaging providers 130 to send e-mail messages to any recipient 120 without spamming the recipient's 120 private e-mail address. As explained above since private e-mail addresses change quite often, the ability to keep the recipient's records updated and accurate is extremely if not an impossible task. Additionally, in one embodiment messages are kept in a messaging server bin 112 contained on the messaging server 110 to permit each recipient 120 to review and query the message without loading the message into and jamming their own private e-mail systems or computer.

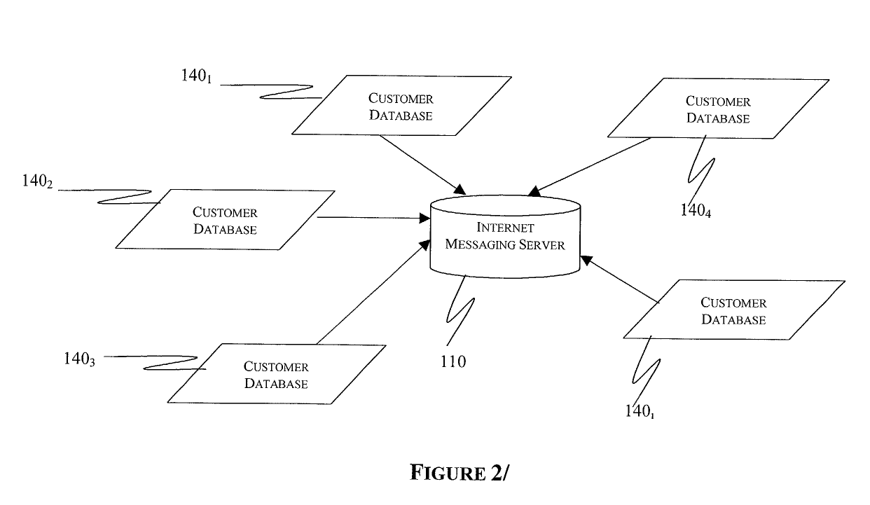

Referring now to FIG. 2., to create the unique Internet addresses the messaging server 110 receives at least one customer database 140₁ to 140ᵢ; where i signifies i number of customer databases. Each customer database 140 may be separately owned by a different entity (referred to herein generally as Database Owner) and represent different information, for instance, customer database 140₁ may be owned by a credit card company and consist of a database representing the company's card holders including individual and businesses; customer database 140₂ may be owned by a utility company representing only residential customers; and customer database 140₃ may be owned by a business-to-business information company representing businesses that are registered with the company.

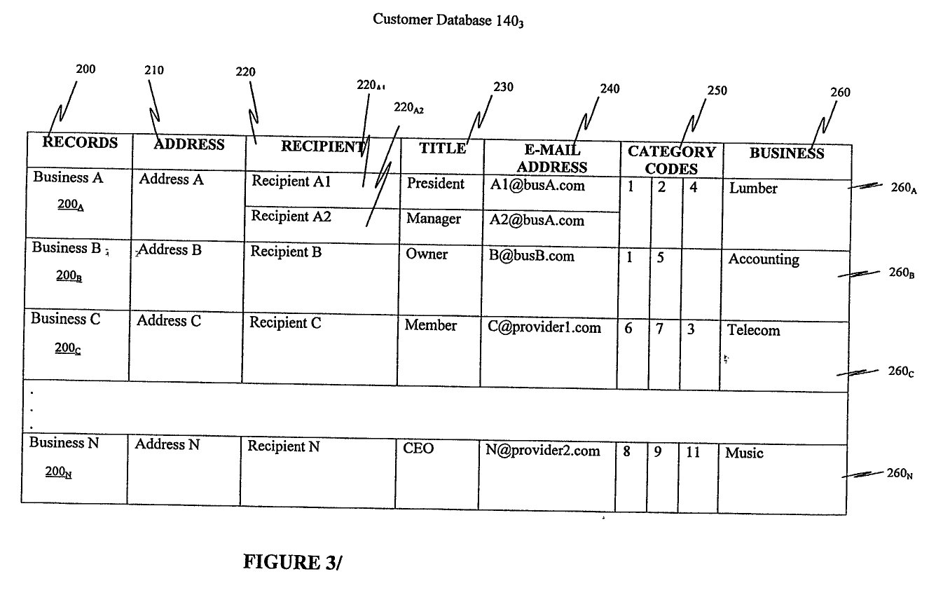

For further clarification purposes only customer database 140₃ owned by a business-to-business information company is illustrated in FIG. 3. It is important to note that the fields illustrated are for exemplary purposes only, as will become more apparent in further detail below. As such the amount or specific information contained in the fields or records should not limit the scope of the invention. As illustrated, the customer database 140₃ includes a plurality of records, each record containing a plurality of fields, which represent information compiled by the information company associated to the various businesses.

For a closer examination, each record 200 represents a business 200_{A} to 200_{N}, where N corresponds to N number of records such that record 200_{A} corresponds to Business A; 200_{B} corresponds to Business B; 200c corresponds to Business C and 200_{N} corresponds to Business N. Corresponding to each record are a number of fields that separately contain additional information corresponding to the specific business or record. For example, the fields may include an address field 210, a recipient field 220, a title field 230, a personal e-mail field 240, category fields 250 and a business type field 260. The address field 210 may also include sub fields to store the city, state and zip separately from the address. The recipient field 220 may also include sub fields, in the event that more then one recipient is required or desired for a particular business. For example, record 200_{A} for Business A has two recipients, Recipient A1 220_{A1} and Recipient A2 220_{A2}. The first recipient, Recipient A1, is the president while the second recipient, Recipient A2, is the manager of the business. The customer database may also include sub fields for the title 230 such that each recipient 220 has a corresponding title or further identification.

Each record may further include category codes 250 that permit the Database Owner, of the customer database 140₃, to track different information about the business or about the recipient. For example, Business A 200_{A}, which is a lumber business according to business information field 260_{A}, may also offer services such as delivery, or sells other related items such as paint. The category codes may also be related to the recipient 220, for example if the recipient is an office manager then the category codes 250 may relate to paper goods, or office supplies as well as mailing labels and shipping. It is important to note that other codes or information may be included or used to identify the recipient, business or individual records. For example, the customer database may include Standard Industrial Classification (SIC) codes, North American Industry Classification System (NAICS) codes, North American Product Classification System (NAPCS) codes, or even design their own internal code system. For instance, a Database Owner that owns a customer database representing residential telephone customers may include product codes indicating the type of service the residents have, such as call-waiting, call-forwarding, voice mail, or indicating the calling plan the recipient has, such as international or domestic.

The customer database 140 may also contain each recipient's 220 personal e-mail address 240 created and controlled by the recipient or business, which may be private (if the recipient is an individual) or may be corporate owned (if the recipient is an employee of a company). As such the customer database 140 may contain numerous e-mail addresses for various executive or employees of a company. However, as mentioned above, since the personal e-mail addresses 240 change often because the employees may change often within a business or the recipient or business may change providers, it is difficult for the Database Owner to create an effective marketing system over the Internet using available information.

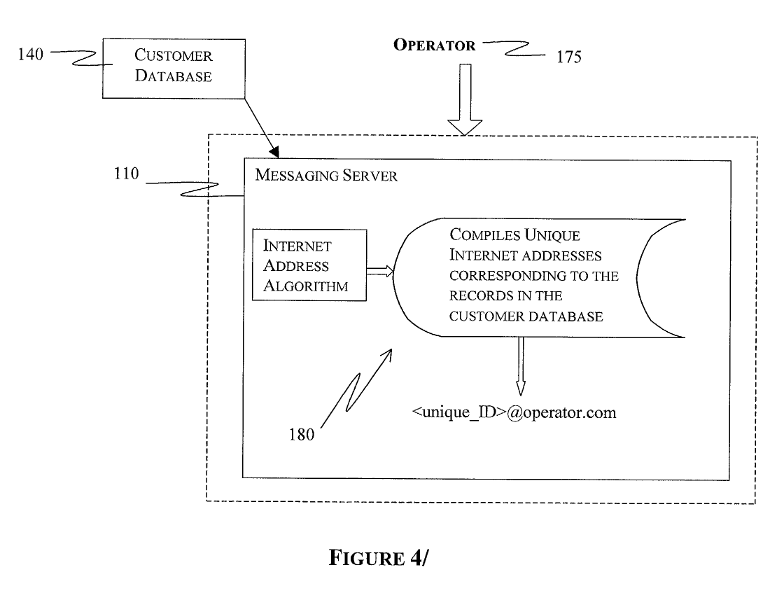

Referring now to FIG. 4, the messaging server 110, which is operated by a third party (referred to herein as “operator” 175) receives the customer databases 140 and creates or compiles a unique Internet address 180 for each record or for each recipient. When the unique Internet address is a unique e-mail address, the unique e-mail address is created using a unique identification or “unique_ID” as the base of the first part of the e-mail address: <unique_ID>@operator.com, where “operator” is the operator 175 of the e-mail messaging server 110. It being fully contemplated the “operator.com” may be any domain name for which the Internet addresses will be provided. As mentioned above, the operator 175 creates and controls the unique Internet address and not the recipient or the end user. As such the Database Owner or other messaging providers do not have to rely on updated e-mail or Internet addresses. The unique ID may also be different for different customer databases. If a customer database was owned by a utility company and represented the utility company's accounts, the utility company could use the messaging server to send monthly statements to its customer's. The messaging server could then compile the unique e-mail addresses based upon information in the customer database, such as the account number.

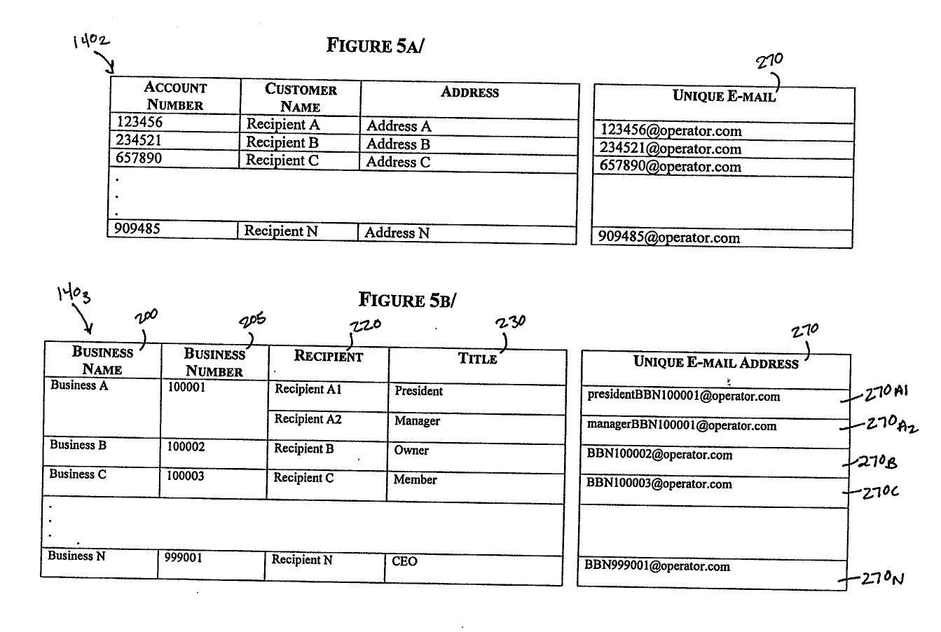

In FIG. 5a, a Database Owner such as the utility company having a customer database 140₂ sends the customer database 140₂ to the messaging server 110, which compiles a unique Internet address database 270, comprised of unique e-mail addresses. Using each customer's pre-assigned account number, unique to the account, the messaging server 110 creates the unique Internet addresses 270 and links or associates the unique Internet address to a corresponding recipient or customer. The Database Owner using the unique Internet addresses 270 can now send statements and other notices to its customers with the premise that the utility company informed the customers that a unique Internet address has been set up and assigned to them. The customer or recipient having accesses to a computer or other communication device set up to access the messaging server 110 can then view, retrieve and possible delete the messages directed to them by the utility company. In addition thereto, the utility company may further provide “blind access” to a messaging provider such as a marketing company or other third company for their limited use of the utility company's unique Internet addresses. With such blind access a third company or messaging provider 130 may compose a message and transmit it to the messaging server 110, discussed in further detail below. The messaging server 110 will then direct the message to the recipients via their unique e-mail addresses. Moreover, the messaging provider 130 will not be given direct access to the unique Internet addresses and therefore cannot market the recipients at will, which in essence becomes SPAM mail. The recipient receiving the messaging provider's 130 message may then respond at will, without the fear of the messaging provider 130 gaining access to the recipient's private e-mail address.

In another example, FIG. 5b is a Database Owner is a business-to-business information company having a customer database similar to customer database 140₃. The customer database 140₃ as previously shown in FIG. 3, contains records or business names 200, recipients 220, titles 230 and various other information. In addition each business record 200 will typically further contain a corresponding business number 205 provided by the Database Owner, which is the business-to-business information company. The messaging server receiving the customer database identifies the unique ID as the business number 205 and compiles the unique Internet addresses 270, which in this example are unique e-mail addresses, using the business number. However, since each business may contain more than one recipient 220, for instance Business A has Recipient A1 and Recipient A2, the unique Internet address may tag the title of the recipient in front of the unique ID, for example creating a unique e-mail address such as <title><unique_ID>@operator.com. Alternatively, if the messaging server manages multiple customer databases, the messaging server may need to further distinguish the unique ID by inserting a second unique identifier such as the Database Owner's name or initials. For example, if the business-to-business information company is the well known company Dun & Bradstreet, it is also widely known that Dun & Bradstreet assigns a nine digit “D U Ns” number to each business. As such the unique e-mail address could consist of the <title> of the recipient, <DUN> distinguishing Database Owner from other customer databases, and then the <DUNs number>, which is the first unique ID assigned to each business. As such the unique Internet address, or e-mail address would look like or presidentDUN123456789@operator.com or managerDUN123456789@operator.com. If there is only one recipient, such as in Business C 200_{C} in the customer database 140₃ the unique e-mail address may be BBN100003@operator.com, where BBN denotes business-to-business information company's initials. It is important to note, that the unique Internet address, while it is linked or associated to a recipient in the customer database, if the specific recipient was replaced or changed the unique Internet address would still correctly identify the new recipient, without having to be changed.

For example, in customer database 140₃ Business A's first recipient, Recipient A1, which is the president is assigned the following unique Internet address presidentBBN100001@operator.com. Using this unique Internet address the Database Owner or other messaging providers may be able to identify Recipient A1 and send messages specifically targeted thereto, as described above and in greater detail below. However, if Recipient A1 is fired and replaced by Recipient A3, the unique Internet address 270_{A1} would still correctly identify and target the new recipient without having to change the unique Internet address, even though the personal information identifying the new recipient changed and even though the customer database 140₃ changed. Since the unique Internet addresses are controlled and created by the messaging server and are unique to the record and not necessarily unique to the specific individual, the messages would still be correctly directed to the new recipient.

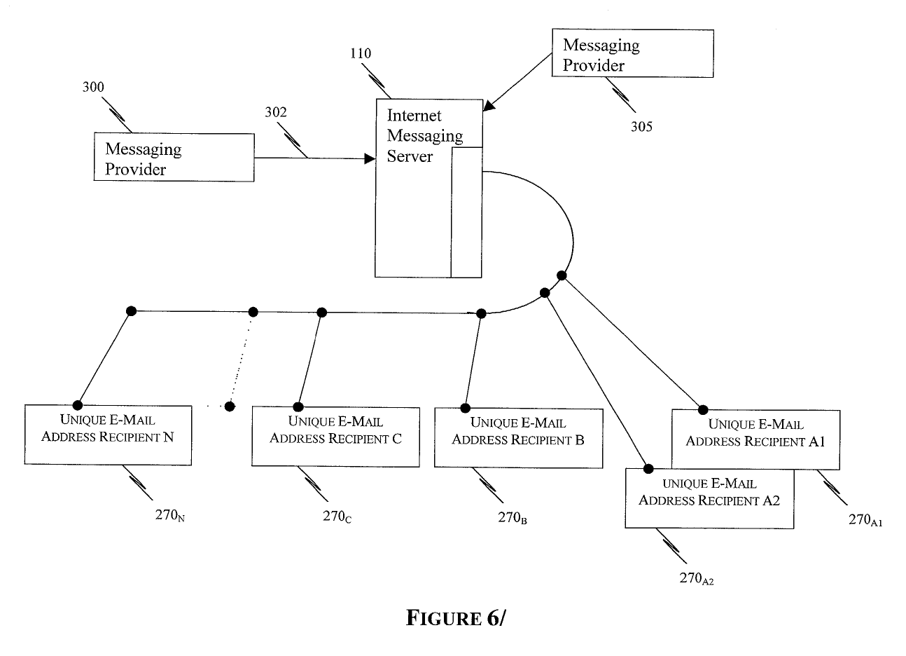

In addition, the customer database 140₃ also contains information regarding the type of business or various other category codes, described above. As such a more direct marketing strategy can be created. Referring now to FIGS. 6, 5b and 3, a messaging provider 300 creates a message 302 for certain types of business, for example only accounting businesses. The messaging provider 300 transmits the message 302 to the messaging server 110 directing the message to be sent to all businesses in category code 5, which for example is an accounting code. The messaging server searches the customer database 140₃ for the category code 5 and finding a match directs the message to or stores the message in the unique Internet address corresponding to the businesses with category code 5, Business B or Recipient B's unique Internet address 270_{B}. Similarly, a second messaging provider 305 creating a message 307 for the managers of any company, which is designated for example by category code 1, sends the message to the messaging server 110. The messaging server 110 searching the database finds two businesses with category code 1, Business B and Business A. The message is automatically directed (stored on the server) to the unique e-mail address 270_{B} corresponding to Business B as it only has one recipient. However, Business A has two recipients. To determine which recipient the e-mail is directed to, the messaging server may then distinguish the recipients by title, since the message is directed to managers, the message will be directed to Recipient A2, which is the manager of Business A.

It should be further noted, that the messages could be directed to various recipients in a database using any field. For example, messages can be sent to recipients living in a specific city or state if the database contains separate fields. The messaging server will typically designate appropriate means for which a messaging server or the Database Owner may correctly target the specific recipient. In some instances, the messaging server may simply word search the message for specific words and compare or match the specific words with the information stored in the fields. The messaging server that would facilitate the targeting and identification of the correct or targeted recipients can install various known search methods and means and base the criteria on their own personal needs.

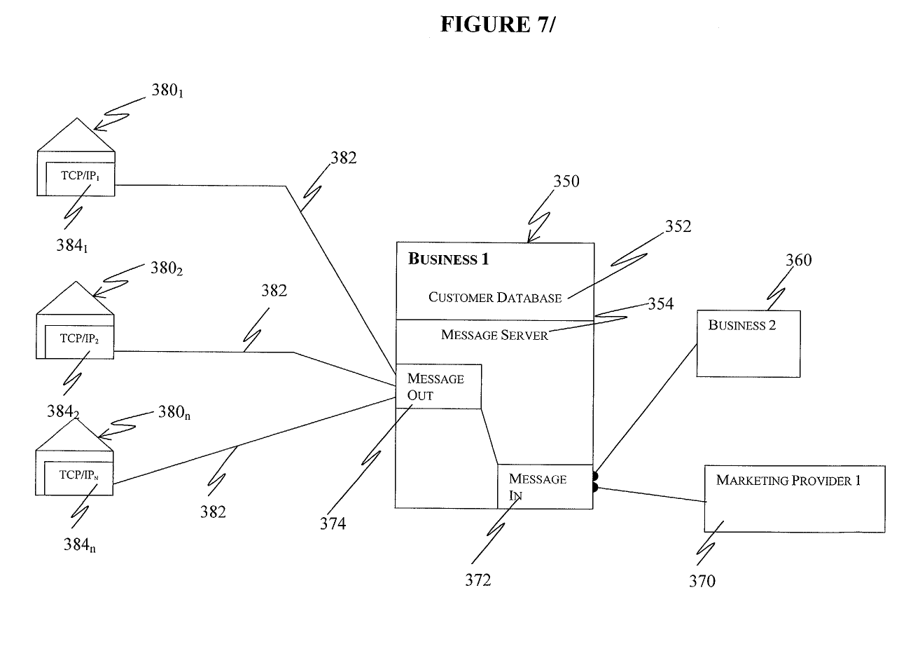

In another embodiment of the present invention, the messaging server 110 can be maintained by Database Owner themselves. Referring now to FIG. 7, Business1 350 owns or maintains a customer database 352 and operates a messaging server 354. As mentioned above, the messaging server 354 receiving the customer database 352 creates unique Internet addresses for each customer of Business1 350. Providing each customer with the ability to access the messaging server 354 permits the customers to retrieve, view and delete their messages without the need of providing a personal or private Internet addresses, such as private e-mail addresses. In addition thereto, Business1 350 may permit outside businesses such as Business2 360 and marketing providers 370 to access the messaging server 354 to directly market the Business1 350 customers.

However, when Business1 350 is for example a utility company, as depicted in FIG. 7, the ability to maintain accurate unique e-mail addresses still may pose a problem. New customers sign up all the time and old customers move or leave causing Business1 350 to constantly update the customer database and in this case also the unique Internet addresses. In order to maintain the system of the present invention in this embodiment, the unique Internet addresses are created not from a customer number or account number but by a unique residential or business number, which is not predicated on the specific customer, but on the residence or address itself. As such, if the current resident moves, replaced by a new resident the unique Internet address would not change because the residence did not change, only the occupant changed. As used herein, the term “residence” refers not only to the place in which one lives such as a dwelling but also refers to an official home or location of a corporation or business.

As shown in FIG. 7, a plurality of residences 380₁, to 380ₙ are connected through any various connecting means 382 to the messaging server 354 operated by Business1 350. The connecting means may be any wireline or wireless medium. Each residence 380 further includes its own Internet protocol address (IP address), which serves as the unique ID. As such if the residence has a IP address of 202.13.244.15 then the unique Internet address would be 2021324415@operator.com.

In order to communicate effectively with the message server, each residence is equipped with its own Transport Control Protocol (TCP) 384, which establishes a virtual connection between each residence 380 and the message server 354; a destination and a source. Each residence therefore acts as its own host to communicate with the message server 354. The messages may then be sent directly to the residence, therefore, eliminating the need for storage space on the message server 354. Each residence would further include a display means, such as an interactive touch LCD screen, that allows the residence to view, delete and possible respond to the messages received. If the Business1 were a utility company, the Business1 would be able to send bills or messages to its customers and if the customer moves the Business1 would not have to update the unique Internet address in order to communicate effectively with the new resident.

In addition, the Business1 can allow other businesses such as Business2 or marketing Provider1 270 to send messages through its messaging server 354. These outside messages are received by the messaging server 354 in storage area 372. The message server 354 can then determine where the messages are to be sent, similarly described above with reference to specific fields or category codes established in the customer database 352. The messages are then correctly forwarded through a message out area 374 to the correct unique Internet address established by the TCP/IP addresses 384. As such, if Business1 when a gas company, then Business1 could allow the local phone company (Business2) to sends its bills or messages to the resident effectively.

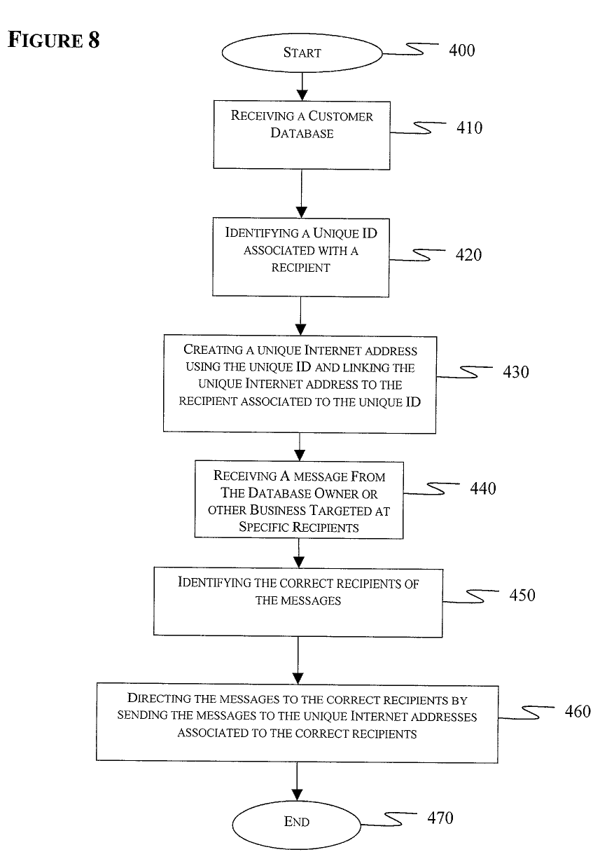

Referring now to FIG. 8 there is illustrated a method for providing permissible Internet direct marketing in accordance with the present invention. Beginning with step 400, the method receives a customer database 140, step 410. While the method would be similar when receiving more than one customer database, the illustration and explanation is done for a single customer database for simplicity reasons only. After receiving the customer database 140, the method identifies a unique ID associated with the recipients in the customer database 140, step 420. While the unique ID may have be pre-determined by the owner of the customer database 140, the unique ID may also be determined by the messaging server if for example multiple recipients are found to be associated with a single record or business. As in the business-to-business example explained above, the messaging server may need to allocate a title or other specific identifier in front of the unique ID. In addition, the other specific identifier may be placed before or after the unique ID in a unique e-mail address, such as <title><unique_ID>@operator.com or <unique_ID><title>@operator.com.

Following step 420, the method creates the unique Internet addresses and links the unique Internet addresses to the recipient or residence associated thereto, step 430. As such the method may now end, in a broad sense in that the unique Internet address has been identified and created by the messaging server and not the end user or the recipient. However, in more specific embodiments of the present invention, the method may follow from step 430, in that the messaging server may receive a message either from the Database Owner or from an outside source such as a second business or marketing provider, step 440. The messaging server identifies the correct recipient(s) of the message, step 450, as explained above. Once identified, the method directs the message(s) to the correct recipient(s) by sending the message(s) to the unique Internet addresses associated to the targeted or correct identified recipient(s), step 460. Also explained above, this step may be defined as storing the message on the message server or sending the message to the recipient when the unique Internet address is determined or defined by the residence or a IP address. Following step 460 the method may end step 470.

From the foregoing and as mentioned above, it will be observed that numerous variations and modifications may be effected without departing from the spirit and scope of the novel concept of the invention. It is to be understood that no limitation with respect to the specific methods and apparatus illustrated herein is intended or should be inferred. It is, of course, intended to cover by the appended claims all such modifications as fall within the scope of the claims.

We claim:

1. A system for creating Internet direct messaging comprising:
means for receiving at least one database containing a plurality of records, each record having information associated to at least one recipient;
means for identifying a unique identification for each recipient and a means for creating a unique Internet address based upon said unique identification, wherein the unique identification is not created or controlled by the recipient;
means for receiving a message directed to targeted recipients in the database;
means for identifying the targeted recipients, of said database, creating a list of identified recipients for which said message is directed to; and
means for directing said message to the unique Internet address of said identified recipients.

2. The system of claim 1, wherein the unique Internet address is a unique e-mail address of the form <unique identification>@<domain> wherein <domain> identifies a domain server for which the unique Internet addresses are located.

3. The system of claim 1, wherein each record of the database includes information associated to a residence of a recipient and the unique identification is an Internet protocol address identifying said residence.

4. The system of claim 1 wherein the unique identification is an account number of the recipient.

5. The system of claim 1, wherein the unique identification is a business number pre-assigned to the recipient.

6. The system of claim 1 further comprising a means for an identified recipient to access the unique Internet address associated to said identified recipient such that the identified recipient may access any messages directed thereto.

7. The system of claim 1, wherein when a record is associated to more than one recipient, the unique identification further includes unique information that distinguishes each recipient within said record from one another, wherein the unique information is not created or controlled by the recipient.

8. The system of claim 7, wherein when the recipient is an employee of a company the unique information is the title of the recipient within said company.

9. The system of claim 1, wherein the step of receiving at least one database comprises receiving at least two databases and the unique identification for each recipient in a database further includes a second unique identifier that distinguishes the recipients of one database from the recipients of another database.

10. A method for creating Internet direct messaging comprising:
receiving a database containing a plurality of records, each record having information associated to at least one recipient; and
identifying a first unique identification for each recipient and creating a unique Internet address based upon said first unique identification, wherein the first unique identification is not created by the recipient.

11. The method of claim 10, further comprising:
receiving a message containing specific information directed to specific recipients in the database;
identifying the specific recipients, of said database, creating a list of identified recipients for which said message is directed to, the step for identifying further based upon matching the information associated to said identified recipients to said specific information contained in said message; and
directing said message to the unique Internet address of said identified recipients.

12. The method of claim 11, wherein each record of the database includes information associated to a residence of a recipient and the unique identification is an Internet protocol address identifying said residence.

13. The method of claim 11, wherein the unique identification is an Internet address.

14. The system of claim 10, wherein when a record is associated to more than one recipient, the unique Internet address includes a second unique identification that distinguishes each recipient within said record from one another, wherein the second unique identification is not created by the recipient.

15. The system of claim 10, wherein the step of receiving at least one database comprises receiving at least two databases and the unique Internet address for each recipient in a database further includes a second unique identifier that distinguishes the recipients of one database from the recipients of another database.

16. A system for Internet direct messaging comprising:
a messaging server being capable of coupling to a messaging provider and a plurality of recipients, and operable to receive a message from said messaging provider and direct said message to at least one identified recipient, of said plurality of recipients; and
the messaging server further in communication with a customer database containing a plurality of records, each records containing information associated to at least one recipient, the messaging server having a means for identifying a unique identification for each recipient, not created by said recipient, and having a means for creating a unique Internet address based upon said unique identification wherein said unique Internet address is linked to the recipient.

17. The system of claim 16 wherein the messaging server further includes a means for identifying all identified recipients of said message by comparing specific information contained in said message to said information associated to the plurality of recipients in the customer database.

18. The system of claim 16 wherein the unique Internet address is an Internet protocol address based upon a residence of each recipient, and each residence includes a transport control protocol enabling the messaging server to direct messages to the transport control protocol of identified recipients.

19. The system of claim 17 wherein when one of the records contains information associated to more than one recipient, the unique Internet address is further based upon additional information that distinguishes each recipient within said record.

20. The system of claim 17 wherein when the messaging server is in communication with a second database containing a plurality of records, each record containing information associated to at least one recipient, the unique Internet address for each recipient in each database is further based upon additional information that distinguishes each recipient within one database from each recipient within another database.
